(19) United States
(12) Patent Application Publication
(10) Pub. No.: US 2010/0243200 A1
(43) Pub. Date: Sep. 30, 2010

(54) SUCTION LINE HEAT EXCHANGER MODULE AND METHOD OF OPERATING THE SAME

(75) Inventors: George Allen Baker, JR., Waterford, WI (US); Jianmin Yin, Racine, WI (US); David J. Garski, Midland, MI (US); Stephen B. Memory, Menomonee Falls, WI (US); Mark R. Hoehne, Lake Villa, IL (US); Gregory G. Hughes, Milwaukee, WI (US); Kylie L. Levake, Racine, WI (US); Joel T. Casterton, Franksville, WI (US); James W. Ryan, South Milwaukee, WI (US); Marvin A. Dokter, Racine, WI (US); Robert A. Willette, Racine, WI (US)

Correspondence Address: MICHAEL BEST & FRIEDRICH LLP, 100 E WISCONSIN AVENUE, Suite 3300, MILWAUKEE, WI, 53202, US

(73) Assignee: MODINE MANUFACTURING COMPANY, Racine, WI (US)

(21) Appl. No.: 12/731,819

(22) Filed: Mar. 25, 2010

Related U.S. Application Data
(60) Provisional application No. 61/163,506, filed on Mar. 26, 2009.

(51) Int. Cl. B60H 1/00; F28F 3/08

(52) U.S. Cl. 165/41; 165/166

(57) ABSTRACT

A heat exchanger module configured for use in a vapor compression based climate control system including a suction line heat exchanger having a plurality of stacked plates configured to accommodate two separate fluid flow paths for heat exchange therebetween. The heat exchanger also includes a first inlet for flow of a high pressure subcooled fluid from a condenser to the module along a first fluid flow path, a first outlet for flow of a low pressure superheated fluid from the module to a compressor along a second fluid flow path, a second outlet for flow of the subcooled fluid from the module to an evaporator along a third fluid flow path, and a second inlet for flow of the low pressure superheated fluid from the evaporator to the module along a fourth fluid flow path. The module also includes a port block with a first conduit for the third fluid flow path and a second conduit for the fourth fluid flow path.

### REFERENCE TO RELATED APPLICATIONS

This application claims priority to Provisional Patent Application No. 61/163,506, filed Mar. 26, 2009, the entirety of which is incorporated herein by reference.

### FIELD OF THE INVENTION

The present invention relates to a heat exchanger, and more specifically relates to a suction line heat exchanger for use in climate control systems operating on the vapor compression cycle for cooling a refrigerant.

### SUMMARY

According to an aspect of the invention, a suction line heat exchanger is provided for transferring heat from a high pressure refrigerant traveling along a first flow path to a low pressure refrigerant traveling along a second flow path. The suction line heat exchanger includes a first mounting surface having a first refrigerant inlet port located along the first flow path and a first refrigerant outlet port located along the second flow path, and further includes a second mounting surface having a second refrigerant inlet port located along the second flow path and a second refrigerant outlet port located along the first flow path. The suction line heat exchanger further includes a first plurality of flow channels fluidly connected to the first refrigerant inlet port to receive the high pressure refrigerant therefrom and fluidly connected to the second refrigerant outlet port to deliver the refrigerant thereto, and a second plurality of flow channels fluidly connected to the second refrigerant inlet port to receive the low pressure refrigerant therefrom and fluidly connected to the first refrigerant outlet port to deliver the refrigerant thereto, the first and second plurality of flow channels being in heat transfer relation with one another.

In some embodiments, the first plurality of flow channels are interleaved with the second plurality of flow channels, with adjacent first and second flow channels being separated from one another by a plurality of essentially planar thermally conductive plates.

In some embodiments a plurality of fin structures are arranged along the first and second plurality of flow channels and are bonded to the thermally conductive plates to provide structural support and increased surface area for heat transfer between the refrigerant flows in adjacent channels.

In some embodiments the suction line heat exchanger includes a fastening means to sealingly attach a first set of refrigerant lines to the first mounting surface, the first set of refrigerant lines comprising a liquid line configured to deliver a high pressure subcooled liquid refrigerant from a condenser to the first refrigerant inlet port and further comprising a suction line configured to deliver a low pressure superheated refrigerant flow from the first refrigerant outlet port to a compressor.

In some embodiments the suction line heat exchanger includes a fastening means to sealingly attach the second mounting surface to a port block comprising a first port configured to receive a pressurized subcooled liquid refrigerant from the second refrigerant outlet port of the suction line heat exchanger and further comprising a second port configured to deliver a low pressure refrigerant flow to the second refrigerant inlet port of the suction line heat exchanger. In some embodiments the port block may comprise an expansion device to expand the pressurized subcooled liquid refrigerant. In some embodiments the port block may comprise both an expansion device to expand the pressurized subcooled liquid refrigerant and a sensing device sensitive to the level of superheat in the low pressure refrigerant flow and configured to adjust the pressure drop in the expansion device in response to said level of superheat.

In one embodiment of the invention a suction line heat exchanger is configured to be installed into a vehicular vapor compression based climate control system comprising a first flow path to deliver a high pressure subcooled refrigerant from a condenser to a port block mounted on a firewall of the vehicle, further comprising a second flow path to deliver a low pressure superheated refrigerant flow from said port block to a compressor, further comprising a third flow path from said port block to an expansion device to receive the high pressure subcooled refrigerant from the port block, and further comprising a fourth flow path from an evaporator to said port block to deliver the low pressure superheated refrigerant flow to the port block, where the first and second flow paths are located on a common side of the firewall and the third and fourth flow paths are located on the opposing side of the firewall. In a further aspect the suction line heat exchanger is configured to mount directly to the port block mounted on the vehicle firewall in order to receive the refrigerant traveling along the first flow path from the condenser and deliver it to the port block, to receive the refrigerant traveling along the second flow path from the port block and deliver it to the compressor along the second flow path, and to transfer heat from the first flow path refrigerant to the second flow path refrigerant.

In another embodiment of the invention a suction line heat exchanger is configured to be installed into a vehicular vapor compression based climate control system comprising a first flow path to deliver a high pressure subcooled refrigerant from a condenser to an expansion valve mounted on a firewall of the vehicle, further comprising a second flow path to deliver a low pressure superheated refrigerant flow from said expansion valve to a compressor, further comprising a third flow path from said expansion valve to an evaporator to deliver the refrigerant from the first flow path as a low pressure liquid/vapor refrigerant to the evaporator, and further comprising a fourth flow path from said evaporator to said expansion valve to deliver the low pressure superheated refrigerant flow to the expansion valve, where the first and second flow paths are located on a common side of the firewall and the third and fourth flow paths are located on the opposing side of the firewall. In a further aspect the suction line heat exchanger is configured to mount directly to the expansion valve mounted on the vehicle firewall in order to receive the refrigerant traveling along the first flow path from the condenser and deliver it to the expansion valve, to receive the refrigerant traveling along the second flow path from the expansion valve and deliver it to the compressor along the second flow path, and to transfer heat from the first flow path refrigerant to the second flow path refrigerant.

Other features, aspects, objects and advantages of the invention will become apparent from a complete reading of the specification and drawings.

### BRIEF DESCRIPTION OF THE DRAWINGS

FIG. 1 is a schematic of a climate control system according to the present invention;

FIG. 2 is a thermodynamic cycle diagram of a refrigerant cycle without a suction line heat exchanger;

FIG. 3 is a thermodynamic cycle diagram of a refrigerant cycle according to the present invention;

FIG. 4 is a perspective view of one embodiment of a suction line heat exchanger according to the present invention;

FIG. 5 is another perspective view of the heat exchanger embodiment of FIG. 4;

FIG. 6 is plan view of the heat exchanger embodiment of FIG. 4;

FIG. 7 is a sectional view taken along the lines VII-VII of FIG. 6;

FIG. 8 is a sectional view taken along the lines VIII-VIII of FIG. 6;

FIG. 9 is an enlarged view of the section IX-IX of FIG. 7;

FIG. 10 is an enlarged view of the section X-X of FIG. 7;

FIG. 11 is an enlarged view of the section XI-XI of FIG. 7;

FIG. 12 is a perspective view of a plate for use in the embodiment of FIG. 4;

FIG. 13 is a perspective view of another plate for use in the embodiment of FIG. 4;

FIG. 14 is a perspective view of one embodiment of a heat exchanger module within the climate control system of FIG. 1, according to the present invention;

FIG. 15 is an exploded perspective view of the heat exchanger module shown in FIG. 14;

FIG. 16 is an exploded view of another embodiment of a heat exchanger module within the climate control system of FIG. 1; and

FIG. 17 is a perspective view of another embodiment of a heat exchanger module according to the present invention; and

FIG. 18 is a diagram of a heat exchanger module for use in a motor vehicle application according to some embodiments of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

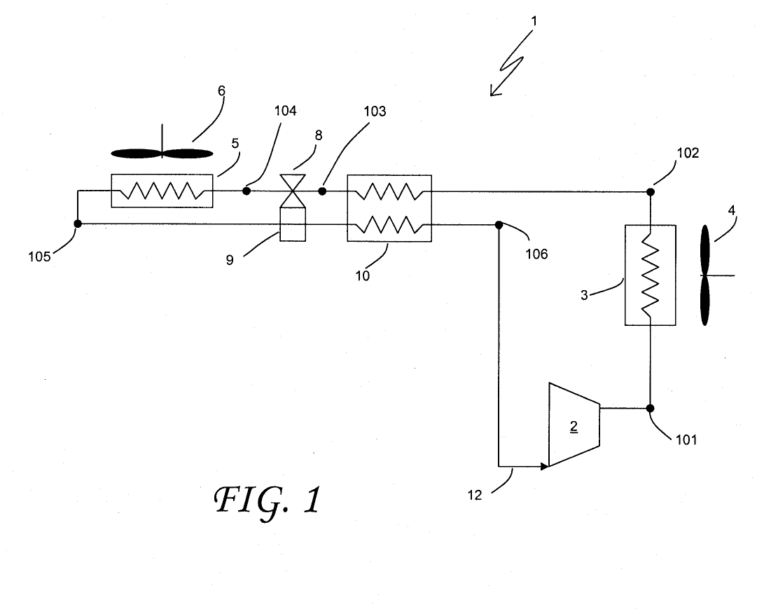

With reference to FIG. 1, a climate control system 1 operating on a vapor compression cycle includes a compressor 2 to pressurize a refrigerant 12 from a lower pressure P1 to a higher pressure P2; a condenser 3 to reject heat from the refrigerant 12 at the higher pressure P2; an expansion device 8 to expand the refrigerant 12 from the higher pressure P2 to the lower pressure P1; and an evaporator 5 to direct heat into the refrigerant 12. The climate control system 1 further includes a first air moving device 4 to provide an air stream to the condenser 3, to which the heat from the refrigerant 12 in the condenser 3 can be rejected; and a second air moving device 6 to provide an air stream to the evaporator 5, from which the heat directed into the refrigerant 12 in the evaporator 5 can be derived. It should be understood by those having skill in the art that the air moving devices 4 and 6 are shown by way of example only, and that various other means for providing a heat transfer medium to exchange heat with a refrigerant in either the condenser or the evaporator are equally well suited within the scope of the invention.

In some systems, the expansion device 8 may take the form of a simple fixed orifice. In other systems, the expansion device may take the form of a variable orifice size valve, the orifice size being adjusted in response to the temperature of the refrigerant 12 downstream of the evaporator 5, said temperature being determined by a sensing device 9. In some such systems the expansion valve 8 and sensing device 9 comprise an expansion assembly 7, typically referred to as a thermostatic expansion valve or TXV.

The climate control system 1 is additionally shown to include an optional heat exchanger 10, sometimes referred to as an internal heat exchanger (IHX) or suction line heat exchanger (SLHX), to transfer heat from the refrigerant 12 downstream of the condenser 3 and upstream of the expansion device 8 to the refrigerant 12 downstream of the evaporator 5 and upstream of the compressor 2. While such a suction line heat exchanger is not required for the climate control system 1 to operate, the inclusion of it will provide certain benefits to the overall system operation.

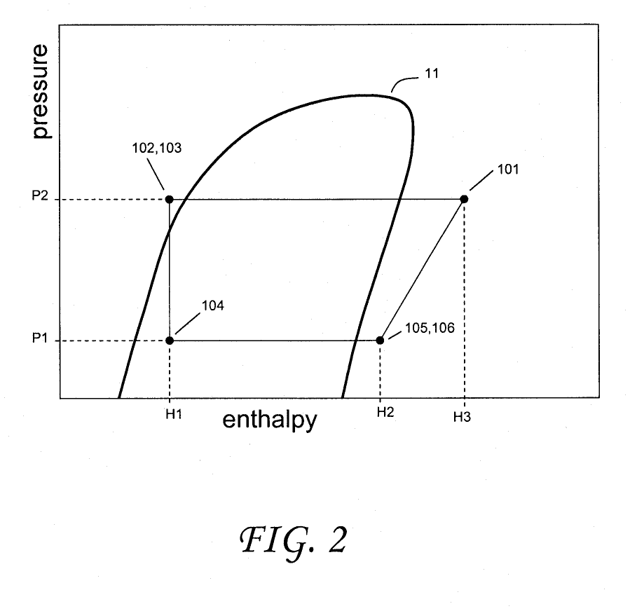

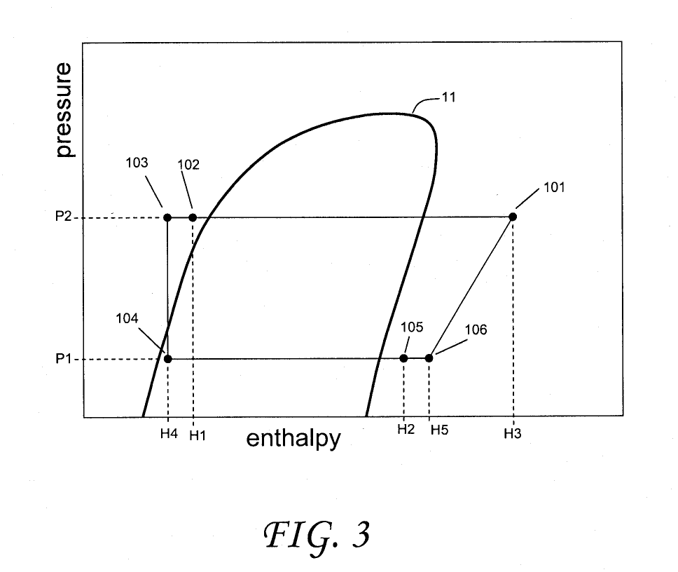

Some of the aforementioned benefits derived from the inclusion of the SLHX 10 will now be described with reference made to FIGS. 2 and 3. FIG. 2 shows a pressure-enthalpy diagram for a refrigerant cycle that does not include the SLHX 10. FIG. 3 shows a pressure-enthalpy diagram for the same refrigerant cycle except that the cycle in FIG. 3 does include the SLHX 10. The diagrams plot the thermodynamic state of the refrigerant 12, as it moves through the climate control system 1, in relation to the saturation curve 11 of the refrigerant 12. For the sake of simplicity, the loss in pressure incurred by the refrigerant as it moves through the system have been ignored (other than the pressure drop through the expansion device) with the understanding that those other pressure losses are of such a small magnitude in comparison to the pressure increase at the compressor that they are not necessary to include in a discussion of the thermodynamic cycle. It should be noted, however, that achieving a highly efficient system relies on minimizing the pressure at the suction side of the compressor. Consequently, minimizing the pressure losses in the system is of high importance, and a preferred embodiment of the invention would be one that is able to keep such losses at a minimum. Understanding the foregoing, for purposes of discussion only, the pressure of the refrigerant from the outlet of the compressor (point 101) to the inlet of the expansion device (point 103) will herein be referred to as the “high pressure” P2, and the pressure of the refrigerant from the outlet of the expansion device (point 104) to the inlet of the compressor (point 106) will herein be referred to as the “low pressure” P1.

Referring now to FIG. 2, as the diagram reflects a system without the optional SLHX 10, the refrigerant 12 does not change its thermodynamic state between points 102 (outlet of the condenser 3) and 103 (inlet of the expansion device 8). Similarly and for the same reason, the refrigerant 12 does not change its thermodynamic state between points 105 (outlet of the evaporator 5) and 106 (inlet of the compressor 2). As can be seen in the diagram of FIG. 2, the condenser 3 must reject a quantity of heat equal to the difference between the enthalpy H3 and the enthalpy H1 from the refrigerant 12. Neglecting any losses or gains to and from the ambient environment other than in the evaporator 5 and condenser 3, this quantity of heat will be equal to the sum of the heat gain of the refrigerant in the evaporator (equal to the difference between the enthalpy H2 and the enthalpy H1) and the compressor (equal to the difference between the enthalpy H3 and the enthalpy H2).

Turning now to FIG. 3, the advantage of including the SLHX 10 in the climate control system 1 will be described. The SLHX 10 will remove an additional quantity of heat from the refrigerant 12 exiting the condenser 3, said quantity being equal to the difference between the enthalpy H1 and the enthalpy H4. The heat so removed will be transferred to the refrigerant 12 prior to entering the compressor 2, thereby increasing its enthalpy from an enthalpy H2 to an enthalpy H5. It should be apparent to one skilled in the art that the quantity of heat removed in the SLHX 10 (equal to H1-H4) enables the refrigerant 12 to enter the evaporator 5 at a lower vapor quality (i.e. closer to the left-hand side of the saturation curve), thereby allowing for enhanced cooling in the evaporator 5. Although the same could in theory be accomplished by increasing the heat removal capacity of the condenser 3, it would be very difficult to accomplish in practice since that additional heat removal would have to be from the subcooled liquid refrigerant. In the system that includes the SLHX 10, the additional condenser heat duty manifests itself as additional sensible cooling of superheated refrigerant vapor, which does not require nearly as much additional heat transfer area in the condenser 5 as would be required to transfer the same quantity of heat from the subcooled liquid refrigerant.

As an additional benefit, the SLHX 10 will ensure that the refrigerant 12 entering the compressor 2 will be fully vaporized to a vapor state. The introduction of refrigerant into a compressor with some fraction of the refrigerant remaining in an unvaporized liquid state can cause damage to the compressor, and is therefore highly undesirable. In typical systems lacking a suction line heat exchanger, this is avoided by operating the system to deliver a greater level of superheat at the exit of the evaporator, thereby ensuring that complete vaporization of the refrigerant will occur in the evaporator. Such operation will, however, result in a decrease in system performance in certain operating conditions. In contrast, the SLHX is able to eliminate the possibility of liquid refrigerant entering the compressor by providing efficient heat transfer between the refrigerant upstream of the compressor and the hot refrigerant upstream of the expansion device. This allows the system to be operated with a low superheat setting without compromising performance, thereby improving the overall efficiency of the system.

As yet another benefit, the inclusion of a SLHX can enable the system 1 to operate with a smaller compressor 2. In a typical mobile air conditioning application, the system is designed to enable a rapid cooling of a hot vehicle interior in high ambient conditions, such as when the vehicle is started after sitting for some time on a hot day. The requirement for achieving this rapid cooling, referred to as “pull-down”, sets the required cooling capacity of the system, and consequently determines the required compressor size. However, for the majority of the time that the system is operating, the required cooling capacity will be much less than the required pull-down cooling capacity, as the system will be operating so as to maintain an already achieved cool vehicle interior temperature. As a result, the compressor 2 will most often be operating at a reduced capacity, which results in very inefficient compressor operation. The system performance improvement resulting from including the SLHX 10 into the system 1 can enable a smaller compressor 2 without sacrificing pull-down performance. Operating with a smaller compressor will increase the compressor efficiency at the reduced operating conditions that the cooling system operates at for the majority of the time, thereby again serving to increase the overall efficiency of the system.

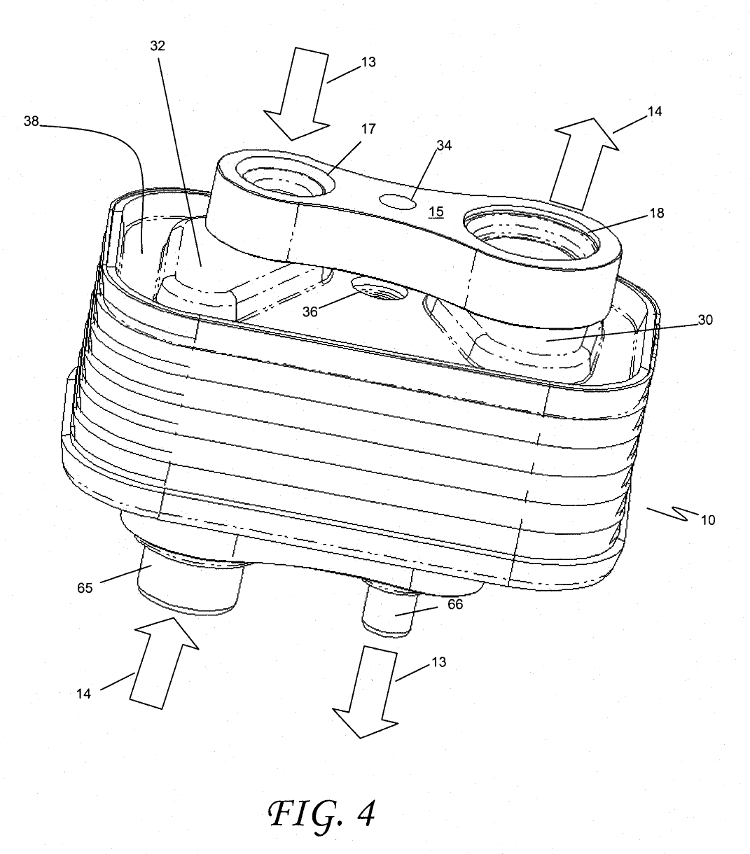

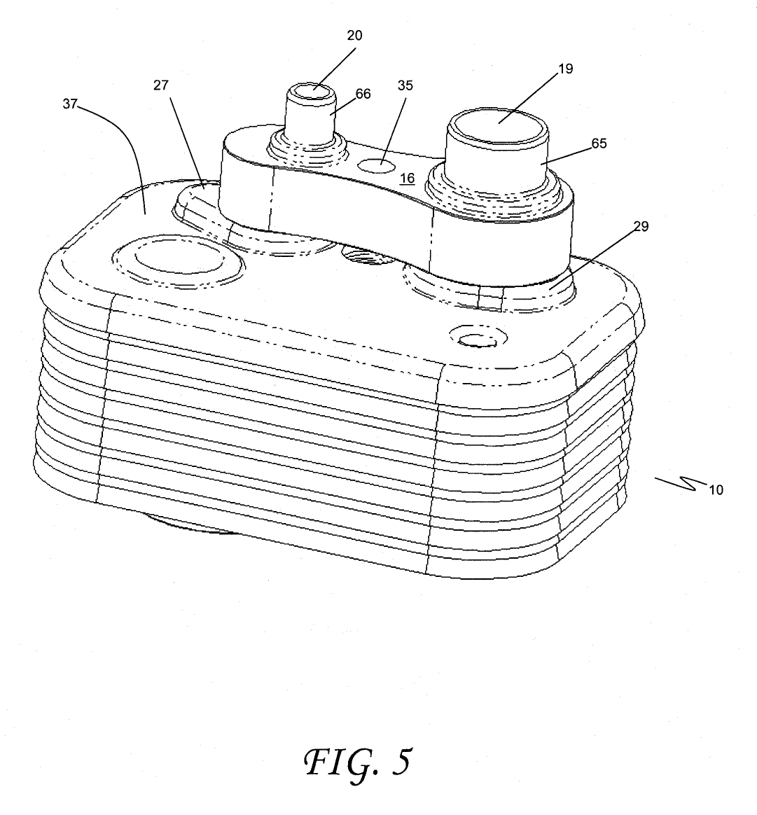

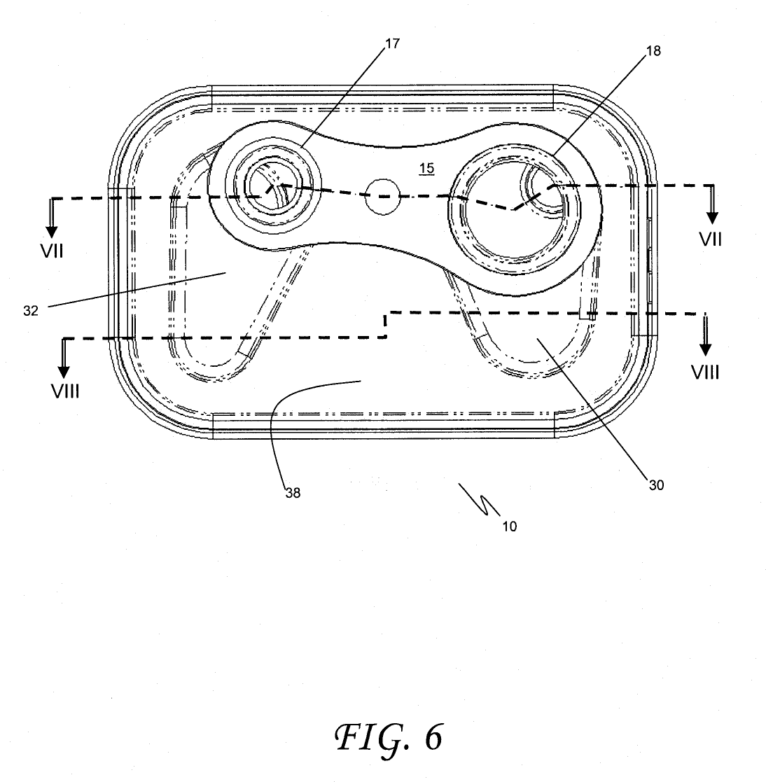

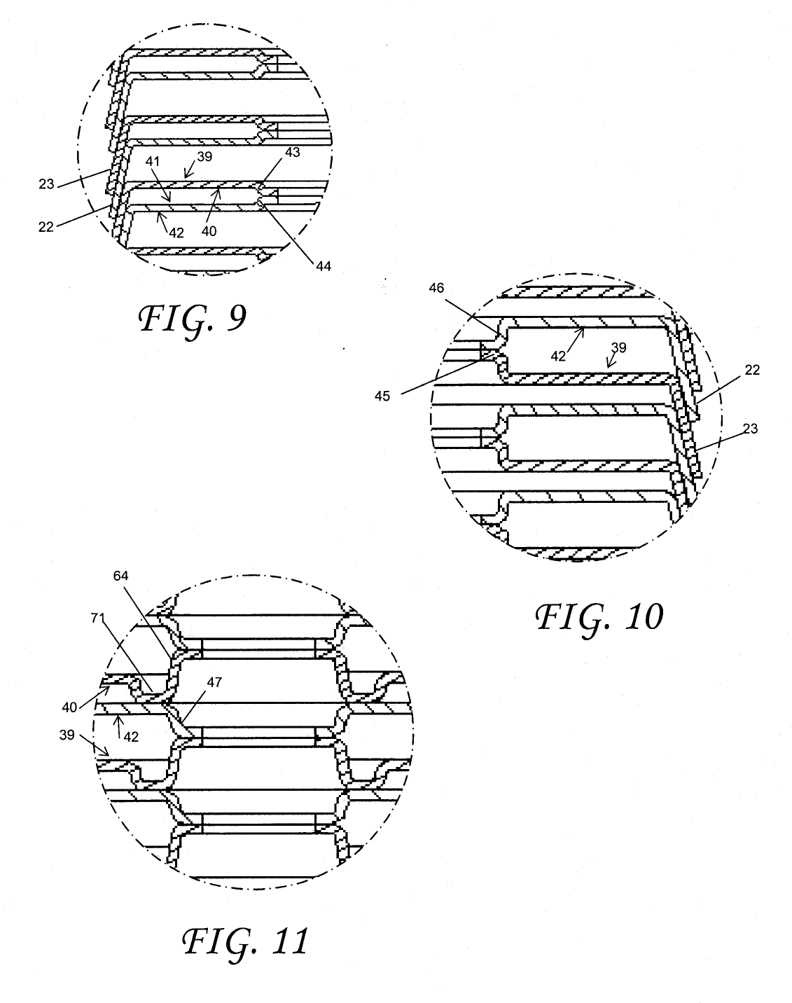

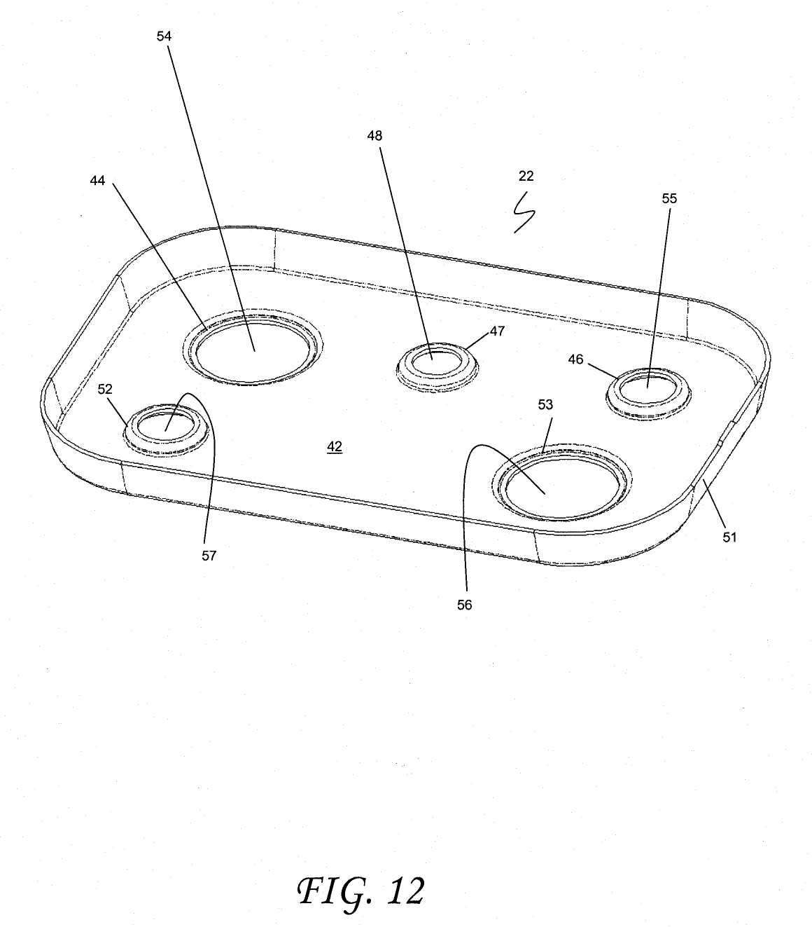

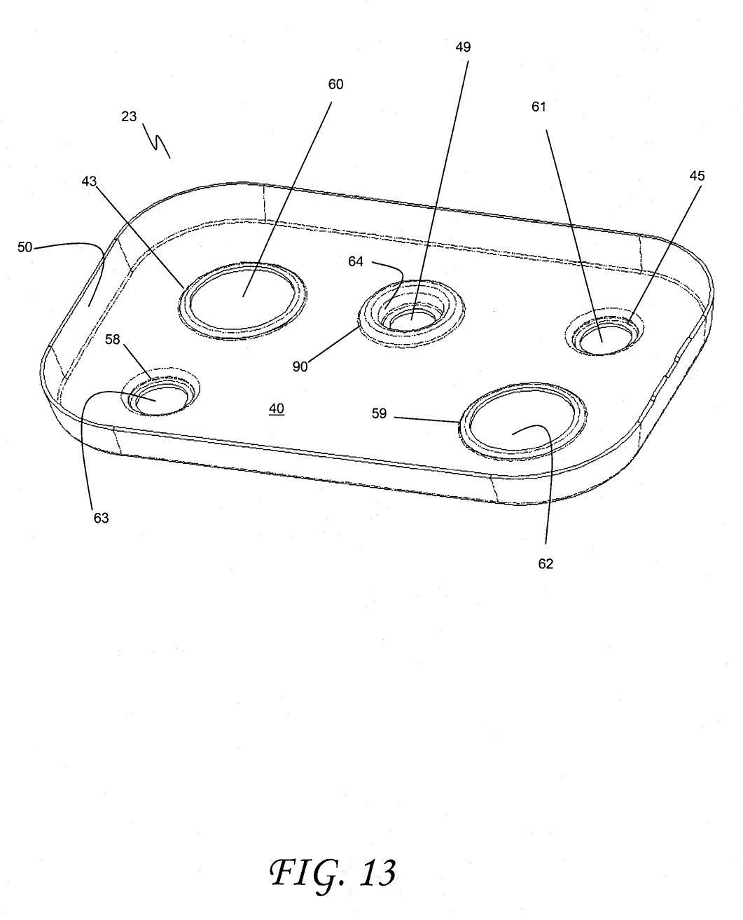

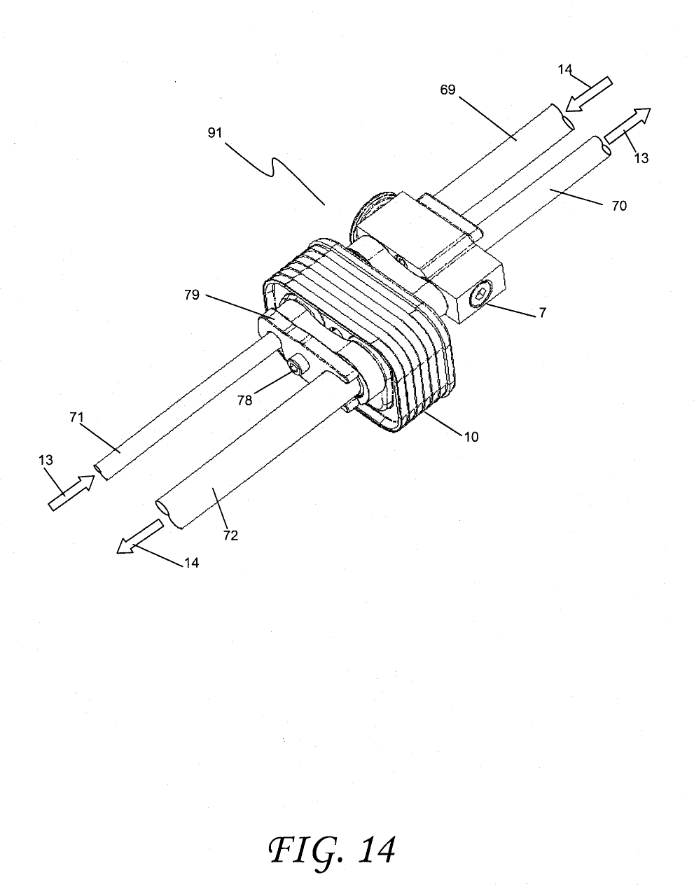

In light of the foregoing, it should be appreciated that a climate control system 1 that does not have a suction line heat exchanger 10 would be able to derive benefit from the inclusion of such a heat exchanger. Accordingly, an embodiment of a suction line heat exchanger that is highly suited for inclusion into a climate control system will now be described, with reference made to FIGS. 4-13.

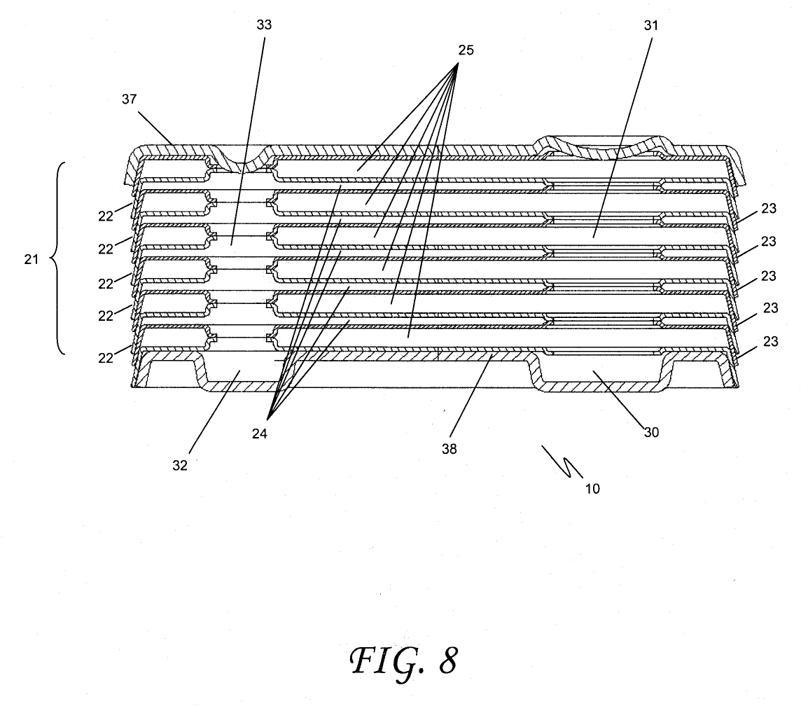

The embodiment of the SLHX 10 shown in FIGS. 4-13 comprises a heat exchanger core region 21 comprised of a plurality of first plates 22 and a plurality of second plates 23, said first and second plates interleaved with one another and stacked together, the outer perimeter of each plate 22 having a continuous flange 51 and the outer perimeter of each plate 23 having a continuous flange 50, the flanges 50 and 51 being formed to allow each of said plates to partially nest within the adjacent plates to form a sealed perimeter, the sealing being accomplished by bonding the plates together such as by brazing. As best seen in FIGS. 8-11, the flanged perimeter geometry is such that the plates 22 and 23 are able to nest within one another by a certain amount before the flanges 50 and 51 of the plates fully engage, thereby creating a first plurality of spaces 24 and a second plurality of spaces 25 between adjacent plates. Each of the spaces 24 is located between a top surface 41 of one of the plates 22 and a bottom surface 40 of the adjacent plate 23 facing said surface 41. Similarly, each of the spaces 25 is located between a top surface 39 of one of the plates 23 and a bottom surface 42 of the adjacent plate 22 facing said surface 39. The terms “top” and “bottom” are used in reference to the orientation shown in the accompanying figures only, and should not be construed to imply any preferred orientation of the heat exchanger 10.

The embodiment of FIGS. 4-13 further comprises a first mounting surface 15 on the exterior of the SLHX 10, said surface 15 having a first inlet port 17 to receive a refrigerant traveling on a first refrigerant flow path 13, and a first outlet port 18 to exhaust a refrigerant traveling on a second refrigerant flow path 14.

The embodiment of FIGS. 4-13 further comprises a second mounting surface 16 on the exterior of the SLHX 10 opposite the first mounting surface 15, said surface 16 having a port tube stub 65 with a second inlet port 19 to receive the refrigerant traveling on the second refrigerant flow path 14, and a port tube stub 66 with a second outlet port 20 to exhaust the refrigerant traveling on the first refrigerant flow path 13.

Continuing with the embodiment of FIGS. 4-13, each of the plates 22 includes an embossment 44 to locally raise the surface 41, and each of the plates 23 includes an embossment 43 to locally raise the surface 40. The surface 41 of an embossment 44 mates against the surface 40 of an embossment 43 to form a sealed joint. The embossment 44 defines an opening 54 and the embossment 43 defines a corresponding opening 60, the plurality of openings 54 and 60 comprising a first internal manifold 28 in fluid communication with the plurality of spaces 25. The internal manifold 28 is additionally in fluid communication with the inlet port 19 by way of a first external conduit 29 formed into a cap plate 37, so that the plurality of spaces 25 comprise a plurality of flow channels for a refrigerant traveling on the second refrigerant flow path 14.

Each of the plates 22 further includes another embossment 53 to locally raise the surface 41, and each of the plates 23 further includes another embossment 59 to locally raise the surface 40. The surface 41 of an embossment 53 mates against the surface 40 of an embossment 59 to form a sealed joint. The embossment 53 defines an opening 56 and the embossment 59 defines a corresponding opening 62, the plurality of openings 56 and 62 comprising a second internal manifold 31 in fluid communication with the plurality of spaces 25. The internal manifold 31 is additionally in fluid communication with the outlet port 18 by way of a second external conduit 30 formed into a cap plate 38, the inlet port 19 and outlet port 18 thereby being in fluid communication with one another.

Each of the plates 22 further includes an embossment 52 to locally raise the surface 42, and each of the plates 23 includes an embossment 58 to locally raise the surface 39. The surface 42 of an embossment 52 mates against the surface 39 of an embossment 58 to form a sealed joint. The embossment 52 defines an opening 57 and the embossment 58 defines a corresponding opening 63, the plurality of openings 57 and 63 comprising a third internal manifold 33 in fluid communication with the plurality of spaces 24. The internal manifold 33 is additionally in fluid communication with the inlet port 17 by way of a third external conduit 32 formed into the cap plate 38, so that the plurality of spaces 24 comprise a plurality of flow channels for a refrigerant traveling on the first refrigerant flow path 13.

Each of the plates 22 further includes another embossment 46 to locally raise the surface 42, and each of the plates 23 further includes another embossment 45 to locally raise the surface 39. The surface 42 of an embossment 46 mates against the surface 39 of an embossment 45 to form a sealed joint. The embossment 46 defines an opening 55 and the embossment 45 defines a corresponding opening 61, the plurality of openings 55 and 61 comprising a fourth internal manifold 26 in fluid communication with the plurality of spaces 24. The internal manifold 26 is additionally in fluid communication with the outlet port 20 by way of a fourth external conduit 27 formed into the cap plate 37, the inlet port 17 and outlet port 20 thereby being in fluid communication with one another.

Each of the plates 23 further includes another embossment 90 to locally raise the surface 40, and another embossment 64 located within the perimeter of the embossment 90, the embossment 64 extending in the direction opposite the embossment 90 to locally raise the surface 39, the depth of the embossment 64 being greater than the depth of the embossment 90. Each of the plates 22 further includes another embossment 47 to locally raise the surface 42, the surface 42 of an embossment 47 mating against the surface 39 of an embossment 64 to form a sealed joint. The raised surface 40 of each embossment 90 mates against the surface 41 of the adjacent plate 22 to likewise form a sealed joint. The embossment 47 defines an opening 48 and the embossment 64 defines a corresponding opening 49, the plurality of openings 48 and 49 forming an open volume 36 extending through the heat exchanger core region 21. The open volume 36 is sealed off from the flow channels 24 by the seal formed at the embossments 90, and is sealed off from the flow channels 25 by the seal formed at the embossments 46 and 47. Alternate ways to create the open volume 36, such as with flanges similar to the flanged perimeters 50, 51 surrounding holes 48 and 49 to form a seal, have also been contemplated by the inventors.

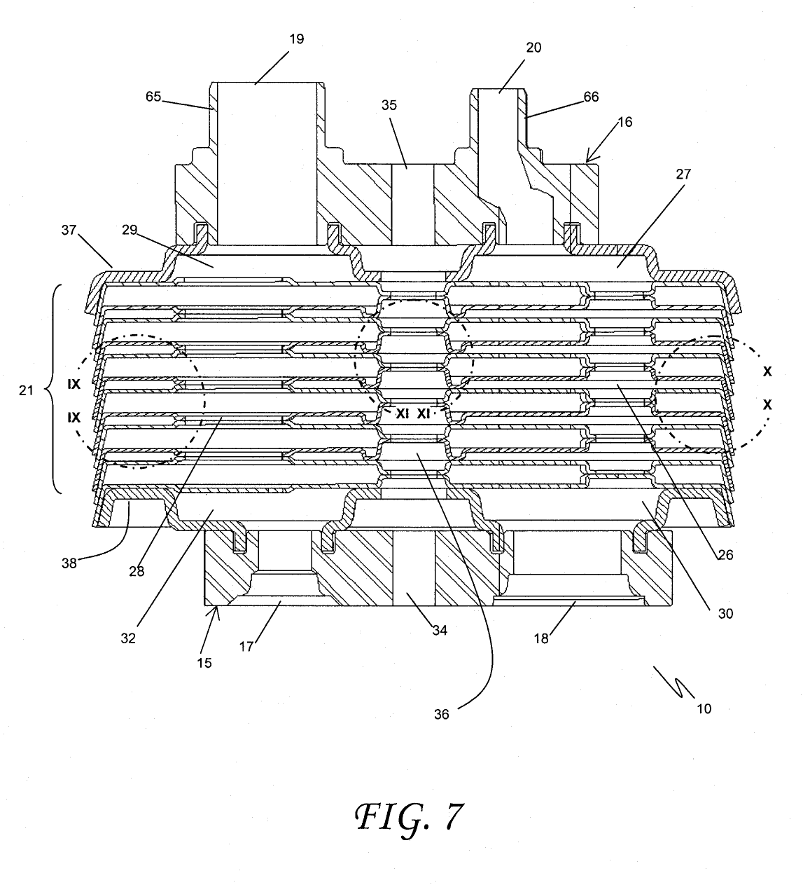

As best seen in FIG. 7, this embodiment of the invention further includes an open volume 34 extending from the open volume 36 to the mounting face 15, and further includes another open volume 35 extending from the open volume 36 to the mounting face 16, the open volumes 34, 35 and 36 being aligned with one another to provide an unobstructed open volume extending between the mounting faces 15 and 16.

Although not shown in the accompanying figures, in some embodiments the SLHX 10 can include extended surface area features in the flow channels 24 and/or in the flow channels 25, in order to provide both improved heat transfer and structural support of the plates. Such extended surface features may comprise a plurality of convoluted fin structures, such as for example lanced and offset fins, with the fin structures relieved in the areas corresponding to the embossments on the plates 22 and 23.

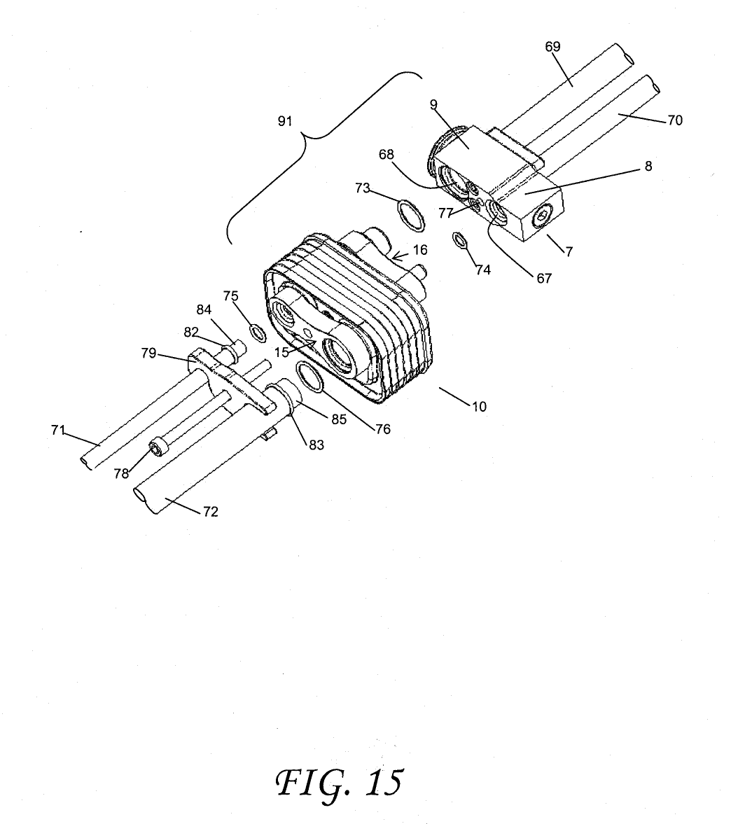

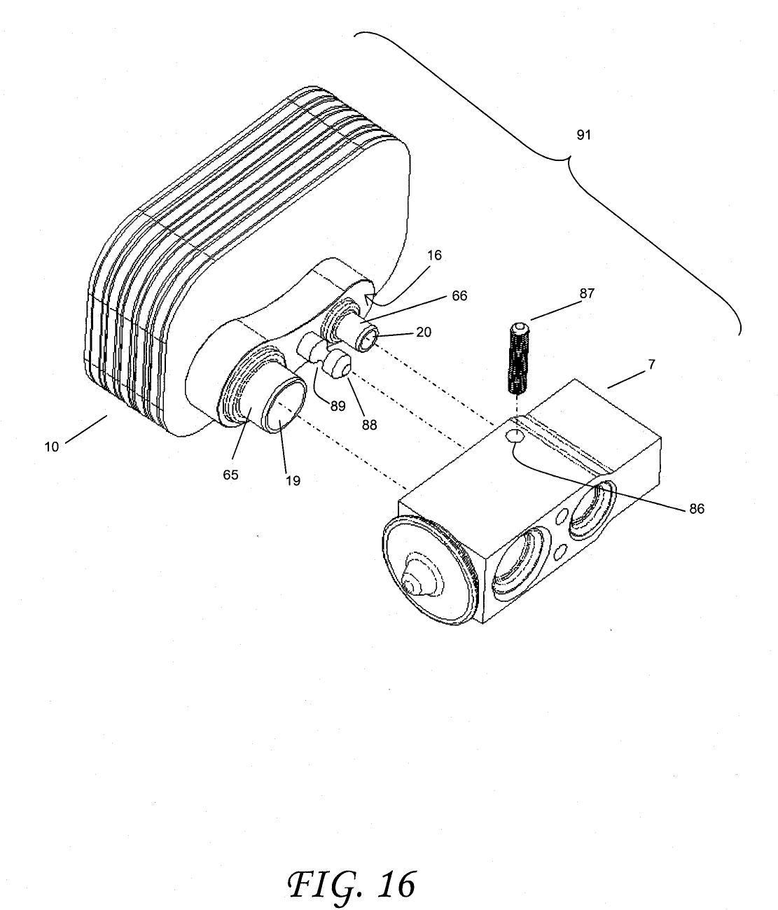

Turning now to FIGS. 14 and 15, the SLHX of FIGS. 4-13 is shown as a part of a heat exchanger module 91 integrated into a climate control system 1 according to an embodiment of the invention. The embodiment shown in FIGS. 14 and 15 includes: a heat exchanger module 91 comprising the SLHX 10 and a port block 7; a first suction line 69 terminating at one end at the port block 7 to comprise a portion of the second refrigerant flow path 14, said portion being located upstream of the SLHX 10; a second suction line 72 to comprise another portion of the second refrigerant flow path 14, said portion being located downstream of the SLHX 10; a first high-pressure refrigerant line 70 terminating at one end at the port block 7 to comprise a portion of the first refrigerant flow path 13, said portion being located downstream of the SLHX 10; and a second high-pressure refrigerant line 71 to comprise another portion of the first refrigerant flow path 13, said portion being located upstream of the SLHX 10.

As best seen in the exploded view of FIG. 15, the second high-pressure refrigerant line 71 terminates in a reduced diameter section 84 and an expanded ring section 82 at the end of the reduced diameter section 84. Similarly, the second suction line 72 terminates in a reduced diameter section 85 and an expanded ring section 83 at the end of the reduced diameter section 85. The embodiment further includes a first o-ring 75 sized to slide over the reduced diameter section 84; a second o-ring 76 sized to slide over the reduced diameter section 85; a third o-ring 73 sized to slide over the port tube stub 65; and a fourth o-ring 74 sized to slide over the port tube stub 66.

In the embodiment depicted in FIGS. 14 and 15 the port block 7 includes an expansion device section 8 with a port 67 adapted to receive the high-pressure liquid refrigerant traveling along the refrigerant flow path 13, the high-pressure liquid refrigerant being expanded in the expansion device section 8, and further includes a sensing device section 9 with a port 68 adapted to receive the low-pressure refrigerant traveling along the refrigerant flow path 14, the amount of superheat present in the refrigerant being measured in the sensing device section 9 in order to vary the pressure drop in the expansion device section 8. In some embodiments the sensing of superheat may be performed remotely at another location along the flow path 14, and the sensing device section 9 of the port block 7 may be simply a fluid connection between the suction line 69 and the port 68. In other embodiments the sensing capability may be eliminated entirely and the expansion device section 8 may comprise a fixed orifice for expanding the refrigerant. In still other embodiments the expansion device section 8 may be entirely removed from the port block 7 and may be located elsewhere along the refrigerant flow path 13. In further embodiments, the expansion device 8 can be provided either in conjunction or integrally with the port tube stub 66 at the second outlet port 20. Similarly, the sensing device 9 can be provided either in conjunction or integrally with the port tube stub 65 at the second inlet port 19.

In some embodiments the heat exchanger module may provide certain advantages for a climate control system 1 on a motor vehicle such as, by way of example only, an automobile or a commercial truck. Such a vehicle may typically include a firewall 93 separating an engine compartment of the vehicle from a passenger cabin of the vehicle. Oftentimes select portions of the climate control system 1 will be located on the engine compartment side of the firewall 93, such as, for example, the compressor 2 and condenser 3. The evaporator 5 will, however, typically be located on the passenger cabin side of the firewall 93 to facilitate the movement of air cooled by the evaporator 5 throughout the passenger cabin, thus requiring some of the fluid lines carrying the refrigerant 12 through the climate control system 1 to pass through the firewall 93.

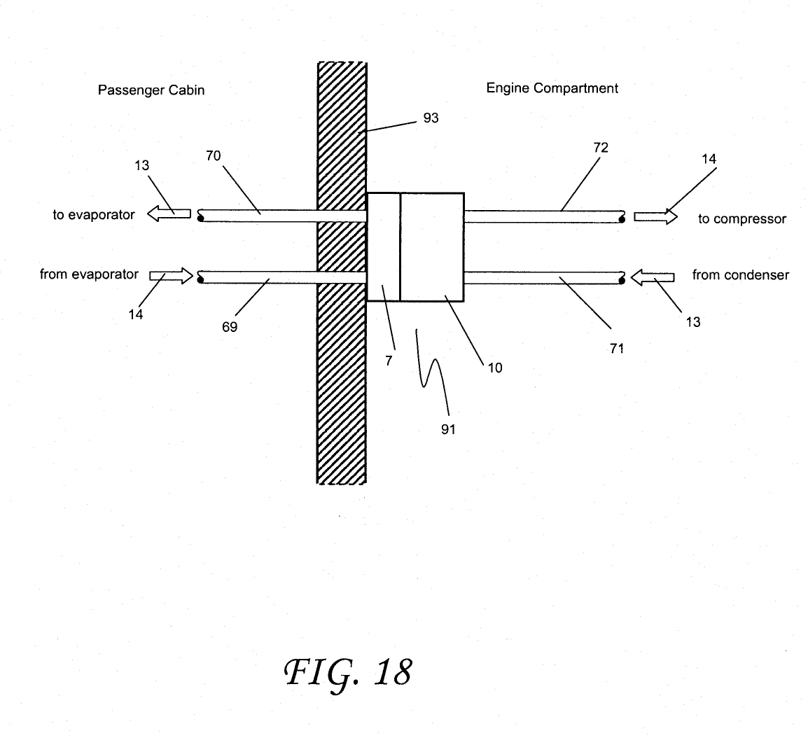

As illustrated in FIG. 18, in some embodiments the port block 7 of the heat exchanger module 91 may be fastened to the firewall 93 to facilitate the passage of refrigerant lines through the firewall 93. In the exemplary embodiment, the refrigerant line 69 from the evaporator (not shown) and the refrigerant line 70 to the evaporator both extend through the firewall 93, terminating at a port block 7 assembled to the engine compartment side of the firewall 93. The SLHX 10 is assembled to the port block 7 to comprise the heat exchanger module 91, and is connected to a condenser and compressor (not shown) located on the engine compartment side of the firewall 93 by way of the refrigerant lines 71, 72. In some other embodiments the port block 7 may be assembled to the passenger cabin side of the firewall 93, whereas in some embodiments the heat exchanger module 91 may be in a location remote from the firewall 93.

The embodiment shown in FIGS. 14 and 15 further includes a clamp 79 and a threaded fastening member 78, the clamp 79 adapted to seat adjacent the mounting surface 15 of the SLHX 10 and bear against the expanded ring sections 82 and 83 of the refrigerant lines 71 and 72, thereby engaging the reduced diameter section 84 of the refrigerant line 71 within the port 17 of the SLHX 10 and compressing the o-ring 75 to maintain a leak-free seal within the port 17, and additionally engaging the reduced diameter section 85 of the refrigerant line 72 within the port 18 of the SLHX 10 and compressing the o-ring 76 to maintain a leak-free seal within the port 18. The threaded fastening member 78 is adapted to pass through the open volumes 34, 35 and 36 of the SLHX 10 and into a threaded mounting hole 77 in the port block 7 in order to provide the clamping force required to seat the clamp 79 against the mounting surface 15 and compress the o-rings 75 and 76, and furthermore to seat the mounting surface 16 of the SLHX 10 against the port block 7 and engage the port tube stubs 65 and 66 into the ports 68 and 67 respectively, thereby additionally compressing the o-rings 73 and 74 to maintain leak-free seals in the ports 67 and 68.

An alternate embodiment of the heat exchanger module 91 is shown in FIG. 16. Certain aspects of the climate control system 1 that were shown in FIGS. 14 and 15 have been removed in order to facilitate illustration of the differences between that embodiment of the heat exchanger module 91 and the present embodiment. In the embodiment of FIG. 16, the openings 48 and 49 and associated flanges 47, 64, and 90 forming open volumes 35 and 36 extending through the SLHX 10 have been eliminated. The open volume 34 is replaced with a threaded hole (not shown) for the threaded fastening member 78 to engage into, thereby accomplishing the clamping required to maintain leak-free seals at ports 17 and 18. A stud 88 extends outward from the mounting surface 16, and includes a necked-down region 89. The threaded hole 77 previously in the port block 7 has been replaced with an unthreaded hole sized to receive the stud 88. In this embodiment the port block 7 includes a threaded hole 86 oriented orthogonal to the stud 88 and located so that a set screw 87 can be threaded into the hole 86 and engage the necked-down region 89 of the stud 88 in order to compress the o-rings 73 and 74, thereby providing leak-free seals at the ports 67 and 68. In this embodiment it may be preferable for the o-rings 73 and 74 to be radially compressed within the ports 68 and 67 to form the leak-free seals, so that the engagement of the set screw 87 and necked-down region 89 serves to maintain leak-free seals without needing to provide compression of the o-rings 73 and 74 onto the mounting surface of the ports 67 and 68.

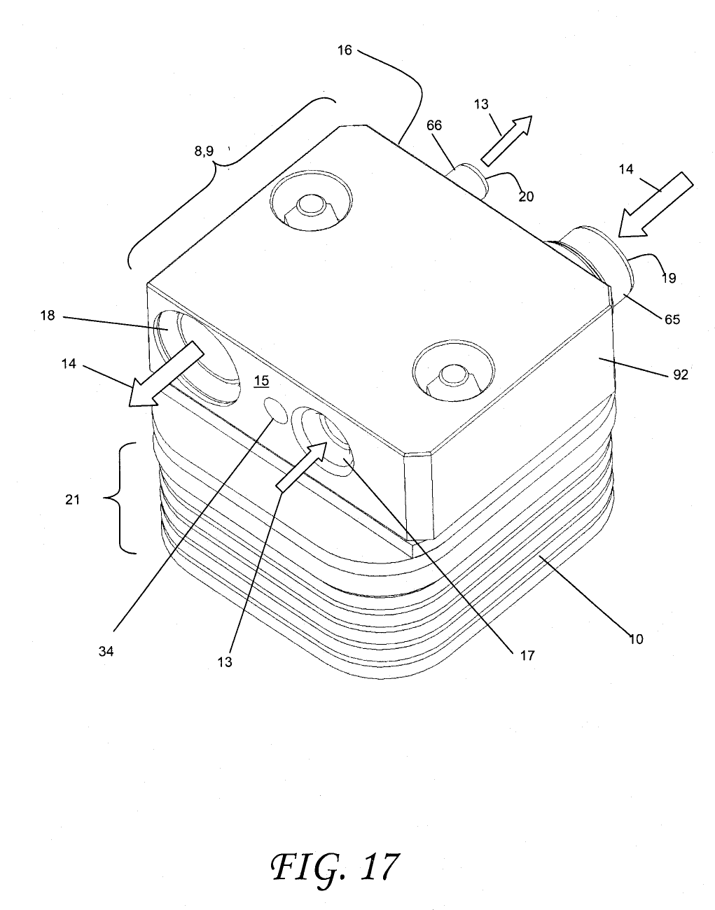

An additional embodiment of a SLHX 10 for use in a heat exchanger module 91 is illustrated in FIG. 17. In this embodiment the core region 21 of the SLHX 10 is spaced away from the region between mounting face 15 and opposing mounting face 16, which are located in a top portion 92 of SLHX 10. The mounting face 16 again includes a port tube stub 65 to receive the refrigerant from the flow path 14, and a port tube stub 66 to deliver the refrigerant to the flow path 13. The mounting face 15 again includes a port 17 to receive the refrigerant from the flow path 13, and a port 18 to deliver the refrigerant to the flow path 14. The top portion 92 between the mounting faces 15 and 16 can optionally include the expansion device 8 and/or the sensing device 9, with the functionality of one or both of these devices thereby being incorporated into the SLHX 10. In some such embodiments the sensing device 9 is adapted to sense the temperature of the refrigerant traveling along the flow path 14 downstream of the heat exchanger core region 21 and upstream of the port 18, corresponding to the point 106 in the system diagram of FIG. 1. This may provide advantages in certain systems, as it can allow all of the refrigerant in evaporator 5 to be in a two-phase liquid-vapor state, thereby increasing the cooling capacity of the system, while still ensuring that the refrigerant exiting the SLHX 10 and entering the compressor 2 is fully vaporized.

Various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

What is claimed is:

1. A heat exchanger module configured for use in a vapor compression based climate control system, the module comprising:
a suction line heat exchanger including a plurality of stacked plates configured to accommodate two separate fluid flow paths for heat exchange therebetween;
a first inlet for flow of a high pressure subcooled fluid from a condenser to the module along a first fluid flow path;
a first outlet for flow of a low pressure superheated fluid from the module to a compressor along a second fluid flow path;
a second outlet for flow of the subcooled fluid from the module to an evaporator along a third fluid flow path;
a second inlet for flow of the low pressure superheated fluid from the evaporator to the module along a fourth fluid flow path; and
a port block with a first conduit for the third fluid flow path and a second conduit for the fourth fluid flow path.

2. The heat exchanger module of claim 2, wherein the module is configured for installation in a vehicle and the port block is mounted on a firewall of the vehicle.

3. The heat exchanger module of claim 2, wherein the first and second flow paths are located on a common side of the firewall and the third and fourth flow paths are located on the opposing side of the firewall.

4. The heat exchanger module of claim 1, wherein the suction line heat exchanger is configured to mount directly to the port block.

5. The heat exchanger module of claim 4, further comprising a fastener for securing the heat exchanger to the port block.

6. The heat exchanger module of claim 5, wherein the plurality of stacked plates further defines an open volume to receive at least a portion of the fastener.

7. The heat exchanger module of claim 1, wherein the first conduit of the port block comprises an expansion device.

8. The heat exchanger module of claim 1, wherein the second conduit of the port block comprises at least one of a temperature and a pressure sensor.

9. The heat exchanger module of claim 1, further comprising an expansion device, wherein the module is configured for installation in a vehicle and the expansion device is mounted on a firewall of the vehicle.

10. The heat exchanger module of claim 1, wherein the stacked plates of the suction line heat exchanger are secured to a mounting block comprising the first inlet, first outlet, second inlet, and second outlet.

11. A heat exchanger module, comprising:
a suction line heat exchanger for transferring heat from a high pressure fluid traveling along a first flow path to a low pressure fluid traveling along a second flow path, the heat exchanger including a stack of spaced-apart alternating first and second plates positioned between cap plates, each of the first and second plates defining four apertures and an embossment surrounding each aperture, the apertures and embossments configured in alignment to form four fluid manifolds extending through the stack, first and second manifolds connected by flow space between first sides of the first plates and second sides of the second plates comprising the second fluid flow path, and third and fourth manifolds connected by flow space between second sides of the first plates and first sides of the second plates comprising the first fluid flow path; and
a port block with a first conduit for the first flow path and a second conduit for the second flow path.

12. The heat exchanger module of claim 11, wherein the mounting surface is substantially parallel to the stacked plates.

13. The heat exchanger module of claim 11, wherein the mounting surface is substantially orthogonal to the stacked plates.

14. The heat exchanger module of claim 11, wherein the suction line heat exchanger is configured to mount directly to the port block.

15. The heat exchanger module of claim 11, further comprising a fastener for securing the heat exchanger to the port block.

16. The heat exchanger module of claim 15, wherein the plurality of stacked plates further defines an open volume to receive at least a portion of the fastener.

17. The heat exchanger module of claim 11, wherein the first conduit of the port block comprises an expansion device.

18. The heat exchanger module of claim 11, wherein the second conduit of the port block comprises at least one of a temperature and a pressure sensor.

19. The heat exchanger module of claim 11, wherein the module is configured for installation in a vehicle and the port block is mounted on a firewall of the vehicle.

20. The heat exchanger module of claim 19, wherein a first suction line and a first high pressure refrigerant line are located on a common side of the firewall and a second suction line and a second high pressure refrigerant line are located on the opposing side of the firewall.

21. The heat exchanger module of claim 11, further comprising an expansion device, and wherein the module is configured for installation in a vehicle and the expansion device is mounted on a firewall of the vehicle.

22. The heat exchanger module of claim 11, wherein the stacked plates of the suction line heat exchanger are secured to a mounting block comprising an inlet and an outlet for the first fluid flow path and an inlet and an outlet for the second fluid flow path.
